(19) United States
(12) Patent Application Publication
(10) Pub. No.: US 2025/0296060 A1
(43) Pub. Date: Sep. 25, 2025

(54) Monitoring System for an Epoxy Resin Mixer

(71) Applicants: Gerald Gear, Mosinee, WI (US); Raymond Breer, Albuquerque, NM (US)

(72) Inventors: Gerald Gear, Mosinee, WI (US); Raymond Breer, Albuquerque, NM (US)

(21) Appl. No.: 18/609,411

(22) Filed: Mar. 19, 2024

(51) Int. Cl. B01F 35/21; B05B 12/00; B05B 12/08; B05B 12/14; C08G 59/00

(52) U.S. Cl. CPC B01F 35/2115; B01F 35/2111; B01F 35/2113; B05B 12/006; B05B 12/084; B05B 12/1418; C08G 59/00

(57) ABSTRACT

An epoxy resin mixing station for use in applying epoxy mixtures to construction surfaces is described. The epoxy resin mixing station includes inlet pipes for directing epoxy resin and hardening agent into a mixing chamber, pumps for pumping the epoxy resin and the hardening agent, and a monitoring system. The monitoring system records data related to the flow of the epoxy resin and the hardening agent and operation of the epoxy resin mixing station. The monitoring system transmits the recorded data to a cloud-based storage system, from which users can remotely retrieve and access the recorded data.

### BACKGROUND OF THE INVENTION

The present invention relates to epoxy resin mixers. The present invention relates specifically to epoxy resin mixers having monitoring systems that monitor, transfer, and store data related to epoxy resin mixing and application.

### SUMMARY OF THE INVENTION

One embodiment of the present invention provides for a monitoring system for an epoxy resin mixer for use in applying epoxy mixtures to construction surfaces. The epoxy resin mixer includes a mixing chamber, a first inlet pipe configured to direct a flow of resin into the mixing chamber, and a second inlet pipe configured to direct a flow of hardening agent into the mixing chamber. The monitoring system is used to monitor compliance of the applied epoxy mixture with predetermined specifications. The monitoring system includes a plurality of first inlet sensors coupled to the first inlet pipe and configured to record first inlet data including temperature, pressure, and flow rate of the resin within the first inlet pipe. The plurality of first inlet sensors includes a first temperature sensor, a first pressure sensor, and a first flow meter. The monitoring system includes a plurality of second inlet sensors coupled to the second inlet pipe and configured to record second inlet data including temperature, pressure, and flow rate of the hardening agent within the second inlet pipe. The plurality of second inlet sensors includes a second temperature sensor, a second pressure sensor, and a second flow meter. The monitoring system includes a data transmitter configured to transmit recorded data to a remote cloud-based storage system, the recorded data including the first inlet data and the second inlet data. The remote cloud-based storage system is configured to transmit the recorded data to a remote data retrieval device, the remote data retrieval device accessing the recorded data through a mobile application.

Another embodiment of the present invention provides for an epoxy application system for use in applying epoxy mixtures to construction surfaces including a monitoring system. The monitoring system is used to monitor compliance of the applied epoxy mixture with predetermined specifications. The epoxy application system includes a vehicle, an epoxy resin mixer coupled to the vehicle, a first inlet pipe configured to direct a flow of resin into the epoxy resin mixer, a second inlet pipe configured to direct a flow of hardening agent into the epoxy resin mixer, and a data processing system. The data processing system includes a plurality of first inlet sensors coupled to the first inlet pipe and configured to record first inlet data including temperature, pressure, and flow rate of the resin within the first inlet pipe. The plurality of first inlet sensors includes a first temperature sensor, a first pressure sensor, and a first flow meter. The data processing system includes a plurality of second inlet sensors coupled to the second inlet pipe and configured to record second inlet data including temperature, pressure, and flow rate of the hardening agent within the second inlet pipe. The plurality of second inlet sensors includes a second temperature sensor, a second pressure sensor, and a second flow meter. The data processing system includes a data transmitter configured to wirelessly transmit recorded data to a remote cloud-based storage system, the recorded data including the first inlet data and the second inlet data. The remote cloud-based storage system is configured to transmit the recorded data to a remote data retrieval device.

Still another embodiment of the present invention provides for a method for operating and monitoring an epoxy resin mixer for use in applying epoxy mixtures to construction surfaces. The method includes activating an epoxy resin mixing system such that a first epoxy resin mixture component and a second epoxy resin mixture component are pumped into a mixing chamber, mixed together, and applied to a construction surface, recording data related to operation of the epoxy resin mixing system via a monitoring system, transmitting the recorded data to a cloud-based storage system, storing the recorded data on the cloud-based storage system, and remotely retrieving the recorded data from the cloud-based storage system using a data retrieval device. The monitoring system includes a flow meter, a temperature sensor, and a pressure sensor. The recorded data includes the flow rate, temperature, and pressure of at least one of the first epoxy mixture component and the second epoxy mixture component while being pumped within the epoxy resin mixing system. The first epoxy mixture component is an epoxy resin, and the second epoxy mixture component is a hardening agent.

Additional features and advantages will be set forth in the detailed description which follows, and, in part, will be readily apparent to those skilled in the art from the description or recognized by practicing the embodiments as described in the written description and claims thereof, as well as the appended drawings. It is to be understood that both the foregoing general description and the following detailed description are exemplary.

The accompanying drawings are included to provide further understanding and are incorporated in and constitute part of the specification. The drawings illustrate one or more embodiments, and together with the description serve to explain the principles and operation of various embodiments.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of an epoxy resin mixing system, according to an exemplary embodiment.

FIG. 2 is a detailed top view of a pumping system and monitoring system of the epoxy resin mixing system of FIG. 1, according to an exemplary embodiment.

FIG. 3 is a schematic view of an epoxy resin mixing system, according to an exemplary embodiment.

FIG. 4 is a method for automatically adjusting mix ratios within an epoxy resin mixing system, according to an exemplary embodiment.

FIG. 5 is a method for operating and monitoring an epoxy resin mixer including data collection, transfer, storage, and retrieval.

### DETAILED DESCRIPTION

Referring generally to the figures, various embodiments of an epoxy resin mixing system are shown. Embodiments of the epoxy resin mixing system include an innovative design to provide for a variety of desired characteristics, including adjustable ratios of epoxy mixture components based on the relative speeds of multiple separately motor driven-pumps, collection and storage of monitoring data related to epoxy resin mixing and application processes, and automatic adjustment of ratios of the epoxy mixture components following analysis of the monitoring data. In some conventional epoxy resin mixers, a single electric motor drives multiple pumps, such as via a chain drive, that pump the components of an epoxy mixture. The ratio of the components of the epoxy mixture depends on the flow rates of the components, which are dictated by the ratio of the sprocket sizes associated with each pump. As the pumps wear or deteriorate at different rates, the ratio of the components of the epoxy mixture deviates from the original ratio, requiring repair or replacement of parts to correct.

Applicant has found it beneficial to provide an epoxy resin mixer that includes multiple pumps that dictate the ratio of epoxy mixture components in which the pumps are driven by multiple, separate electric motors. This allows for the flow rate of each component of the epoxy mixture to be adjustable by altering the speed of an individual electric motor, resulting in a cost-effective and time-efficient method of adjusting the mix ratio of the epoxy mixture components. Applicant has also found it beneficial to provide an epoxy resin mixer that includes a monitoring system that collects, stores, and transfers data related to the epoxy mixing and application process. This allows users to determine whether the epoxy mixing and application processes comply with predetermined standards and regulatory requirements, which is often impossible to determine with conventional epoxy resin mixers that do not include such monitoring systems. Applicant has further found it beneficial to provide an epoxy resin mixer that monitors the actual mix ratio of the components of an epoxy mixture and automatically adjusts the flow rate of the components when the actual mix ratio deviates from a predetermined mix ratio by a predetermined tolerance. This allows the epoxy resin mixer to maintain an actual mix ratio within a tolerance of a predetermined mix ratio when operating conditions of the epoxy resin mixer change without requiring manual readjustments or repairs.

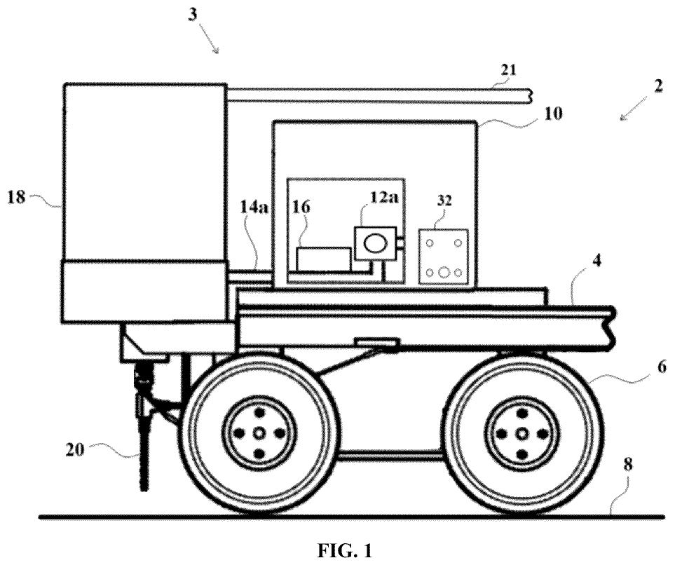

Referring to FIG. 1, an epoxy resin mixing system 2 is shown, according to an exemplary embodiment. Epoxy resin mixing system 2 includes an epoxy resin mixer 3, and a mobile platform 4 coupled to a truck tractor or vehicle 6. Epoxy resin mixing system 2 is configured to apply an epoxy mixture to a substrate 8, such as a roadway, highway, bridge, walkway, parking lot, bike pathway, playground, etc. Vehicle 6 is configured to move epoxy resin mixer 3 such that the epoxy mixture can be applied in multiple locations along substrate 8. In a specific embodiment, portions of epoxy resin mixer 3 are housed in a high voltage feeding enclosure. Epoxy resin mixer 3 can include a 24 V power supply to power the components of epoxy resin mixer 3.

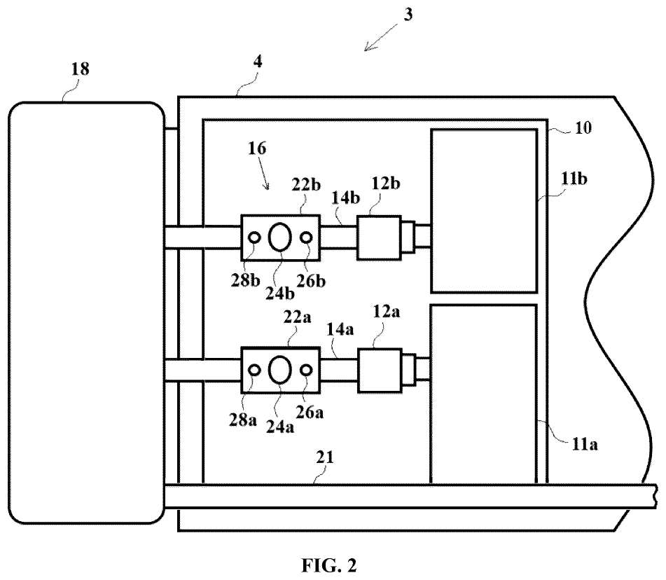

As shown in FIG. 2, epoxy resin mixer 3 includes at least one storage container 10, a first pump 12a, a second pump 12b, a first inlet pipe or tube 14a, a second inlet pipe or tube 14b, a monitoring system 16, and a mixing chamber 18. Storage container 10 contains a first epoxy mixture component and a second epoxy mixture component that is stored separately from the first epoxy mixture component. In a specific embodiment, the first epoxy mixture component is an epoxy resin, and the second epoxy mixture component is any activating agent or hardening agent that one skilled in the art would use in an epoxy mixture. In some embodiments the ratio of the first mixing component and the second mixing component is about 1:1 or about 2:1.

The first and second epoxy mixture components can be stored in separate compartments 11a and 11b, respectively, of storage container 10, or in separate storage containers 10. Storage container 10 is coupled to mixing chamber 18 by pipes 14a and 14b. Pipes 14a and 14b provide individual and separate conduits to transfer the first epoxy mixture component and the second epoxy mixture component, respectively, to mixing chamber 18 such that first epoxy mixture component and the second epoxy mixture component do not mix or combine prior to entering mixing chamber 18. Epoxy resin mixing system 2 also includes an applicator 20 for dispensing and applying the mixed epoxy mixture to substrate 8.

In some embodiments, epoxy resin mixer 3 is configured to store, transfer, and mix additional epoxy mixture components, such as a third epoxy mixture component, a fourth epoxy mixture component, etc. Referring to FIG. 1, epoxy resin mixer 3 can include an aggregate inlet 21 configured to transfer concrete aggregate materials, such as crushed rocks, stone, sand, and/or gravel into mixing chamber 18 such that the epoxy mixture is an epoxy concrete mixture.

Pumps 12a and 12b pump the first epoxy mixture component and the second epoxy mixture component, respectively, from storage container 10 to mixing chamber 18 through pipes 14a and 14b, respectively. First pump 12a and second pump 12b are separate and individually driven pumps such that first pump 12a pumps the first epoxy mixture component and second pump 12b pumps the second epoxy mixture component. In a specific embodiment, each of pumps 12a and 12b include and are powered by independent servo motors. Pumps 12a and 12b can each include gear reducers.

The operating speed of the independent servo motors determines the respective flow rates of the first epoxy mixture component and the second epoxy mixture component into mixing chamber 18. The ratio of the flow rate of the first epoxy mixture component entering mixing chamber 18 and the flow rate of the second epoxy mixture component entering mixing chamber 18 defines an actual mix ratio entering mixing chamber 18 of the first epoxy mixture component and the second epoxy mixture component. As such, increasing or decreasing the operating speed of one or more of the independent servo motors powering first pump 12a and/or second pump 12b can change the actual mix ratio of the first epoxy mixture component and the second epoxy mixture component entering mixing chamber 18.

As shown in FIG. 2, monitoring system 16 includes sets of line sensors 22a and 22b. Line sensors 22a are coupled to first pipe 14a, and line sensors 22b are coupled to second pipe 14b. Line sensors 22a and 22b are configured to record data related to the flow of first epoxy mixture component and second epoxy mixture component, respectively, through first pipe 14a and second pipe 14b, respectively. Each feature of line sensors 22a discussed below also applies to line sensors 22b, such that similarly numbered features of line sensors 22a that record data related to the first epoxy mixture component, first pump 12a, and/or first pipe 14a are present in line sensor 22b and record data related to the second epoxy mixture component, second pump 12b, and/or second pipe 14b.

Line sensors 22a include a flow meter 24a that measures the flow rate of the first epoxy mixture component through first pipe 14a. Flow meter 24a can include a differential pressure flow meter, an orifice flow meter, a venturi flow meter, a pilot tube flow meter, a positive displacement flow meter, a reciprocating piston flow meter, an oval-gear meter, a nutating-disk flow meter, a rotary-vane meter, a helix flow meter, a volumetric flow meter, a turbine flow meter, a vortex flow meter, a magmeter, an ultrasonic flow meter, and/or a mass flow meter. In a specific embodiment, flow meter 24a is a circular gear flow meter configured to measure flow rates of between 0.01 L/min-4 L/min within an accuracy of 0.5%. In some embodiments, flow meter 24a produces a control signal of between 0-20 mA, between 4-20 mA, between 0-5 V or between 0-10 V. In a specific embodiment, flow meter 24a produces high speed pulsed signals in which the frequency of the pulses proportionally corresponds to the measured flow rate.

Flow meter 24a records data in-line off of first pipe 14a, including the weight and volume of material passing through first pipe 14a. Applicant has found it beneficial to monitor the weight and volume of material passing through pipes 14a and 14b to record accurate flow data related to the epoxy mixture components and to assess the application rate of materials applied to substrate 8.

In some embodiments, line sensors 22a include a temperature sensor 26a that records the temperature of the first epoxy mixture component as it flows through first pipe 14a. Temperature sensor 26a include an integrated circuit temperature sensor, a thermistor, a thermocouple, a thermostat, a resistance temperature detector, a thermometer, a radiation thermometer, and/or a thermal imaging device. In a specific embodiment, temperature sensor 26a is a resistance temperature detector configured to measure temperatures between −20 and 100 degrees Celsius and having a probe length of between 10-50 mm and probe diameter between 2-10 mm. Temperature sensor 26a produces a control signal of between 0-20 mA, between 4-20 mA, between 0-5 V, or between 0-10 V.

The temperature data recorded by temperature sensor 26a is recorded in-line off of first pipe 14a. Applicant has found it beneficial to monitor the temperature of both the first epoxy mixture component and the second epoxy mixture component to verify that the epoxy mixture components are dispensed at the proper temperatures as recommended by manufacturers or as required by regulatory bodies, and to indicate whether either temperature requires adjustment.

In some embodiments line sensors 22a include a pressure sensor 28a that records the pressure of the first epoxy mixture component as it flows through first pipe 14a. Pressure sensor 28a can be a physical pressure sensor, a pressure transducer, or a pressure transmitter. In some embodiments, pressure sensor 28a includes an aneroid barometer pressure sensor, a manometer pressure sensor, a bourdon tube pressure sensor, a vacuum pressure sensor, a sealed pressure sensor, a piezoelectric pressure sensor, and/or a strain gauge pressure sensor. In a specific embodiment, pressure sensor 28a is configured to sense pressures between 0 PSIG and 1000 PSIG within an accuracy of 0.75%. Pressure sensor 28a can be a pressure transmitter having a ceramic sensing element. Pressure sensor 28a produces a control signal of between 0-20 mA, between 4-20 mA, between 0-5 V, or between 0-10 V.

The pressure data recorded by pressure sensor 28a is recorded in-line off of first pipe 14a. Applicant has found it beneficial to monitor the pressure of both the first epoxy mixture component and the second epoxy mixture component within pipes 14a and 14b to verify that the epoxy mixture dispensing equipment is operating properly, troubleshoot any issues with the epoxy mixture dispensing equipment, and to provide insight regarding the flow of materials through pipes 14a and 14b.

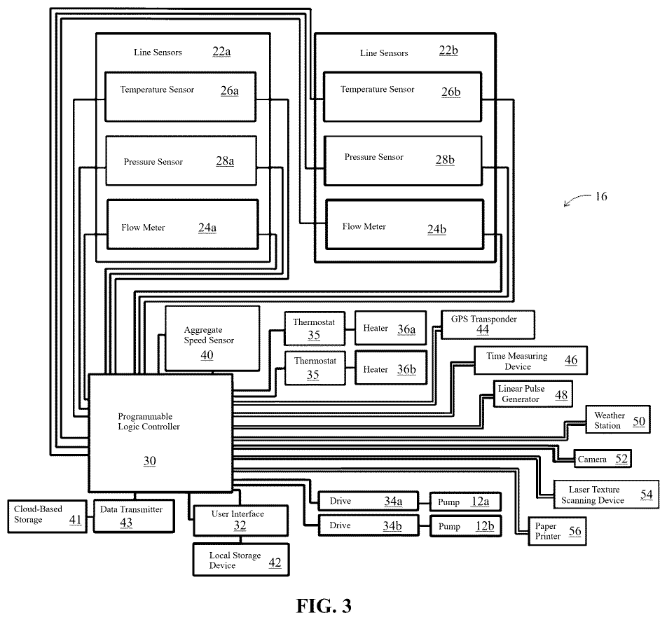

Referring to FIG. 3, a schematic drawing of electrical components of epoxy resin mixer 3 including monitoring system 16 and electronically controlled pumps 12a and 12b. Monitoring system 16 includes a programmable logic controller (PLC) 30, a user interface 32, and servo drives 34a and 34b. Line sensors 22a and 22b and user interface 32 are connected to and in communication with PLC 30. PLC 30 sends signals to line sensors 22a and 22b to record data related to the flow of the first epoxy mixture component and the second epoxy mixture component, respectively, and receives signals from line sensors 22a and 22b regarding the recorded data. PLC 30 is configured to receive high speed inputs generated by flow meters 24a and 24b. In a specific embodiment, PLC 30 includes a high-speed counter configured to receive the high-speed inputs or pulses generated by flow meters 24a and 24b. PLC 30 is also configured to send digital outputs and receive digital inputs to control servo drives 34a and 34b and user interface 32. PLC 30 can include an analog expansion card for sending analog outputs to servo drives 34a and 34b and for receiving analog inputs from line sensors 22a and 22b.

User interface 32 allows users to control epoxy resin mixer 3 with operational inputs, such as commands to start and stop pumping and mixing the first epoxy mixture component and the second epoxy mixture component and to set a predetermined mix ratio of the first epoxy mixture component and the second epoxy mixture component. In a specific embodiment, user interface 32 includes a start button, a stop button, a prime button, a stop light, and a ready light. User interface 32 can include a touch screen. In a specific embodiment, user interface 32 includes a color LCD touch screen.

Servo drives 34a and 34b are connected to and controlled by PLC 30. Servo drives 34a and 34b drive the independent servo motors that power each of pumps 12a and 12b, respectively. As such, PLC 30 can send signals to servo drives 34a and 34b to increase or decrease the speeds of the independent servo motors and thereby increase or decrease the flow rate of material pumped by either of pumps 12a and/or 12b, respectively. By increasing or decreasing the flow rate of material pumped by either of pumps 12a and/or 12b, PLC 30 can adjust the mix ratio of the first epoxy mixture component and the second epoxy mixture component entering mixing chamber 18. In a specific embodiment, servo drives 34a and 34b are 3-phase servo drives. Servo drives 34a and 34b can operate at 5.5 kW and 230 VAC. In some embodiments, the independent servo motors are 3-phase brushless servo motors. The independent servo motors can operate at 4.5 kW.

As shown in FIG. 3, some embodiments of monitoring system 16 include a heater 36a and a heater 36b. Heater 36a is configured to raise the temperature of the first epoxy mixture component, and heater 36b is configured to raise the temperature of the second epoxy mixture component. Heaters 36a and 36b can be any heating device that one skilled in the art would use for heating epoxy mixture components, such as, for example, a hot air gun, a heat lamp, a convection oven, or a direct contact heating element. Each of heaters 36a and 36b are connected to a thermostat 35 or one of a plurality of thermostats 35. Thermostats 35 are configured to activate and deactivate heaters 36a and 36b in order to adjust the temperature of the first epoxy mixture component and/or the second epoxy mixture component. In a specific embodiment, thermostats 35 are connected to and controlled by PLC 30. In an alternative embodiment, at least one of thermostats 35 is controlled independently of PLC 30 by a standalone control system.

In some embodiments, monitoring system 16 includes an aggregate speed sensor 40. Aggregate speed sensor 40 records data related to the amount of aggregate material that passes through aggregate inlet 21, such as the weight and/or volume of aggregate material that passes through aggregate inlet 21 over a period of time. Monitoring system 16 can also include a local data storage device 42. Local data storage device 42 can be a hard drive, flash drive, memory card, network-attached storage device, and/or disc-based storage device. Local data storage device 42 is connected to and in communication with PLC 30 and is configured to receive and store data recorded by any of the other devices connected to PLC 30.

In some embodiments, monitoring system 16 includes a data transmitter 43. Data transmitter 43 is connected to a network for data transmission, for example, by a mobile communication system, Wi-Fi, and or a wired connection. In some embodiments, data transmitter 43 includes an antenna and connects PLC 30 to a cellular network such that at least a portion of the data transmission process includes wireless data transmission. In a specific embodiment, data transmitter 43 is an ethernet switch including a built-in cellular connection that connects to PLC 30 via an ethernet connection. Data transmitter 43 is configured to transmit data or information recorded by monitoring system 16 and any of the devices connected to PLC 30 to remote locations. In a specific embodiment, data transmitter 43 transmits data recorded by monitoring system 16 to a cloud-based storage system 41, i.e., a remote server hosted on the internet or a network of remote servers hosted on the internet, from which users can then retrieve the stored recorded data remotely.

Monitoring system 16 can include an on-board GPS transponder 44. GPS transponder 44 is connected to PLC 30 such that data collected by GPS transponder 44 is routed through PLC 30, such as to local data storage device 42 or data transmitter 43. In some embodiments, the connection between GPS transponder 44 and PLC 30 includes an RS-485 connection or an RS-232 connection. GPS transponder 44 provides location, date, and time data related to the application of the epoxy mixture to substrate 8. The data collected from GPS transponder 44 can be used to verify that the application of materials to substrate 8 complies with predetermined specifications. The location data collected from GPS transponder 44 can also be utilized with geo-mapping services to assist in providing visual representations of substrate 8 (i.e., roadways) after the epoxy mixture has been applied. For example, the data collected by GPS transponder 44 can be used to overlay representations of the area of substrate 8 over which the materials have been applied on satellite images. The start times and stop times of application of the epoxy mixture are recorded by GPS transponder 44 and used to estimate the time of return to service of substrate 8 following application.

Monitoring system 16 is configured to record linear quantification data of the area of substrate 8 that the epoxy mixture is applied to. In a specific embodiment, monitoring system 16 includes a linear pulse generator 48. The linear pulse generator 48 is coupled to vehicle 6 and records linear quantification data as vehicle 6 travels over substrate 8. The linear quantification data includes the length of substrate 8 over which applicator 20 has traveled while applying the epoxy mixture to substrate 8, i.e., the length of roadway the epoxy mixture has been applied to. This length can be measured in centimeters, meters, kilometers, inches, feet, yards, miles, or any other unit of length. The linear quantification data is used in combination with the flow rate of the first and second epoxy mixture components to determine application rate and thickness of the epoxy mixture applied to substrate 8. In some embodiments, the application rate is calculated as the volume of epoxy mixture applied to substrate 8 per area of substrate 8 upon which the epoxy mixture is applied, such as gallons of epoxy mixture per square foot of substrate 8. The application rate of the epoxy mixture is included in the data recorded by monitoring system 16. The application rate data can be retrieved to verify compliance with specifications set by contractors or other regulating authorities on a real-time basis or in a report following conclusion of the epoxy mixture application process.

Monitoring system 16 includes an on-site weather monitoring device or weather station 50. Weather station 50 includes sensors configured to record data related to the environmental weather conditions proximate to substrate 8 during mixing and application of the epoxy mixture in real time, including temperature, humidity, moisture, rain fall, wind speed, wind direction, heat index, sun light intensity and/or noise level. Weather station 50 is connected to and in communication with PLC 30. In some embodiments, weather station 50 utilizes the SDI-12 serial communication protocol. In some embodiments, the connection between weather station 50 and PLC 30 includes an RS-485 connection or an RS-232 connection. The environmental weather condition data recorded by weather station 50 can be used to demonstrate that the mixing and application of the epoxy mixture complies with manufacturer specifications and specifications set by regulatory authorities. The environmental weather condition data can also be used to calculate estimated cure times for the epoxy mixture once applied to substrate 8.

In some embodiments, monitoring system 16 includes a camera 52. Camera 52 is connected to and in communication with PLC 30. Monitoring system 16 can include a plurality of cameras 52. Camera 52 is positioned and configured to record data related to the application of the epoxy mixture to substrate 8 in the form of images. Camera 52 records initial images of the preparation of substrate 8 prior to application of the epoxy mixture. The initial images can be used to determine if substrate 8 complies with manufacturer and regulatory authority specifications, as well as to provide visual references of the cleanliness and surface profile of substrate 8. Camera 52 is also used to record a photo diary of substrate 8 when epoxy resin mixing system 2 is running, enabled, and/or applying the epoxy mixture to substrate 8 and after application of the epoxy mixture to substrate 8. The images recorded by camera 52 are timestamped to provide an accurate visual record of the progress of the installation of the epoxy resin mixture to substrate 8.

Monitoring system 16 includes a laser texture scanning device 54. Laser texture scanning device 54 is connected to and in communication with PLC 30. Laser texture scanning device 54 records data related to the surface profile and texture of substrate 8. Laser texture scanning device 54 can record data related to the surface profile and texture of substrate 8 before and/or after application of the epoxy mixture. The surface profile data includes measurements of deviations of the surface from a flat surface or the average vertical position of the surface. The deviations can be measure in microns, millimeters, centimeters, mils, inches, or any other unit of length. The data recorded by laser texture scanning device 54 is used to calculate a concrete surface profile (CSP) value in accordance with the International Concrete Repair Institute standards. The data recorded by laser texture scanning device 54 is also used to verify compliance of the surface profile and texture of substrate 8 with manufacturer and regulator specifications.

In a specific embodiment, monitoring system 16 includes a paper printer 56 such that any of the data collected by monitoring system 16 and related to the use of epoxy resin mixing system 2 and the mixing and application of the epoxy resin mixture can be printed at the installation site.

In some embodiments, monitoring system 16 is formed as a built-in component of epoxy resin mixer 3. For example, at least one of the devices of monitoring system 16 is an integral component of first and second pipes 14a and 14b, mixing chamber 18, applicator 20, and/or vehicle 6 such that monitoring system 16 is a component of epoxy resin mixer 3 at the time that epoxy resin mixer 3 is first assembled. In alternative embodiments, epoxy resin mixer 3 is assembled prior to monitoring system 16, and monitoring system 16 is later attached to epoxy resin mixer 3. In this way, monitoring system 16 can retrofit pre-existing epoxy resin mixers.

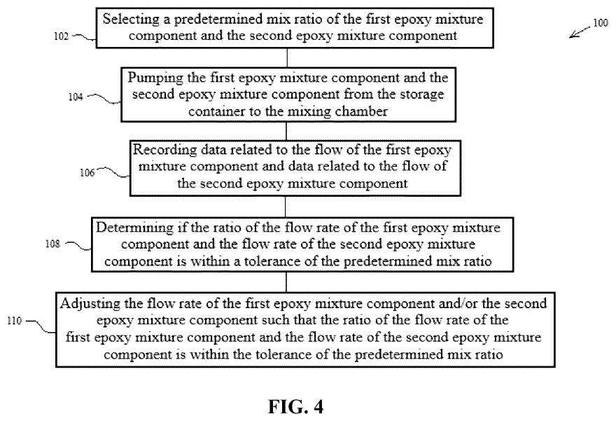

Referring to FIG. 4, a method 100 for automatically adjusting mix ratios within epoxy resin mixing system 2 is shown, according to an exemplary embodiment. Method 100 includes steps 102, 104, 106, 108 and 110. Step 102 includes selecting a predetermined mix ratio of the first epoxy mixture component and the second epoxy mixture component. Step 104 includes pumping the first epoxy mixture component and the second epoxy mixture component from storage container 10 to mixing chamber 18. The first epoxy mixture component and the second epoxy mixture component are each pumped through separate pipes 14a and 14b via separate pumps 12a and 12b. The ratio of the flow rate of the first epoxy mixture component through the first pipe 14a and the flow rate of the second epoxy mixture component through the second pipe 14b defines an actual mix ratio of the epoxy mixture.

Step 106 of method 100 includes recording a first data set from line sensors 22a related to the flow of the first epoxy mixture component within first pipe 14a and recording a second data set from line sensors 22b related to the flow of the second epoxy mixture component within second pipe 14b. In some embodiments, the first data set includes flow rate data related to the flow of the first epoxy mixture component and recorded by flow meter 24a, and the second data set includes flow rate data related to the flow of the second epoxy mixture component and recorded by flow meter 24b. The first data set can also include temperature data related to the first epoxy mixture component and recorded by temperature sensor 26a, and the second data set can also include temperature data related to the second epoxy mixture component and recorded by temperature sensor 26b. PLC 30 sends an electrical signal to line sensors 22a and a signal to line sensors 22b to record the first data set and the second data set, respectively. In a specific embodiment, the first data set and the second data set are stored on local data storage device 42.

Step 108 of method 100 includes determining if the actual mix ratio of the epoxy mixture is within a tolerance of the predetermined mix ratio. The flow rate data of the first data set related to the flow of the first epoxy mixture component is compared with the flow rate data of the second data set related to the flow of the second epoxy mixture component to determine the actual mix ratio of the epoxy mixture. The actual mix ratio is then compared with the predetermined mix ratio to determine a percentage difference between the actual mix ratio and the predetermined mix ratio. The first data set and the second data set are transmitted from line sensors 22a and line sensors 22b, respectively, to PLC 30 to make the determination of whether the actual mix ratio of the epoxy mixture is within the tolerance of the predetermined mix ratio.

In some embodiments, the tolerance for the actual mix ratio is within 1 percent of the predetermined mix ratio. Specifically, the tolerance for the actual mix ratio can be within 0.1 percent or within 0.05 percent of the predetermined mix ratio. In a specific embodiment, the tolerance for the actual mix ratio is within 0.01 percent of the predetermined mix ratio. Applicant has found that a tolerance for the actual mix ratio within 0.01 percent of the predetermined mix ratio provides a variety of benefits, including a high degree of consistency in properties of the epoxy mixture and reduced risk of producing an epoxy mixture that does not comply with regulatory standards.

Step 110 of method 100 includes automatically adjusting the flow rate of the first epoxy mixture component and/or the flow rate of the second epoxy mixture component such that the actual mix ratio is within the tolerance of the predetermined mix ratio. After step 108 is completed, if the actual mix ratio is determined to be outside of the tolerance of the predetermined mix ratio, a programming sequence causes PLC 30 to send electrical signals to servo drive 34a and/or servo drive 34b to adjust the flow rates of the first mixture component and/or the second mixture component. For instance, if the ratio of the flow rate of the first epoxy mixture component and the flow rate of the second epoxy mixture component is greater than the predetermined mix ratio by more than the tolerance, PLC 30 automatically sends an electrical signal to servo drive 34a to reduce the speed of the servo motor driving first pump 12a that is pumping the first epoxy mixture component and/or sends an electrical signal to servo drive 34b to increase the speed of the servo motor driving second pump 12b that is pumping the second epoxy mixture component. Similarly, if the ratio of the flow rate of the first epoxy mixture component and the flow rate of the second epoxy mixture component is less than the predetermined mix ratio by more than the tolerance, PLC 30 automatically sends an electrical signal to servo drive 34a to increase the speed of the servo motor driving first pump 12a that is pumping the first epoxy mixture component and/or sends an electrical signal to servo drive 34b to reduce the speed of the servo motor driving second pump 12b that is pumping the second epoxy mixture component. The speed of the servo motors driving pumps 12a and/or 12b are adjusted until the actual mix ratio is within the tolerance of the predetermined mix ratio.

In a specific embodiment, a first predetermined temperature of the first epoxy mixture component and a second predetermined temperature of the second epoxy mixture component are selected. The first data set includes first actual temperature data of the first epoxy mixture component, and the second data set includes second actual temperature data of the second epoxy mixture component. The first actual temperature of the first epoxy mixture component is compared to the first predetermined temperature to determine if the first actual temperature is within a first temperature tolerance of the second predetermined temperature. The second actual temperature of the second epoxy mixture component is compared to the second predetermined temperature to determine if the second actual temperature is within a second temperature tolerance of the second predetermined temperature. In some embodiments, the first temperature tolerance and/or the second temperature tolerance is within 5 percent, or specifically within 1 percent, of the first actual temperature and the second actual temperature, respectively.

If the first actual temperature of the first epoxy mixture component is below the first predetermined temperature by more than the first temperature tolerance, then heater 36a activates and increases the temperature of the first epoxy mixture component. If the second actual temperature of the second epoxy mixture component is below the second predetermined temperature by more than the second temperature tolerance, then heater 36b activates and increases the temperature of the second epoxy mixture component.

In some embodiments, the first epoxy mixture component and the second epoxy mixture component are then mixed together in mixing chamber 18 to form the epoxy mixture, and the epoxy mixture is applied to substrate 8 through applicator 20. The epoxy mixture can be cured after being applied to substrate 8 to form an epoxy. In a specific embodiment, the epoxy mixture is applied to substrate 8 to form a portion of a roadway. The epoxy mixture can include concrete aggregate materials such that the epoxy mixture applied to substrate 8 is an epoxy concrete mixture.

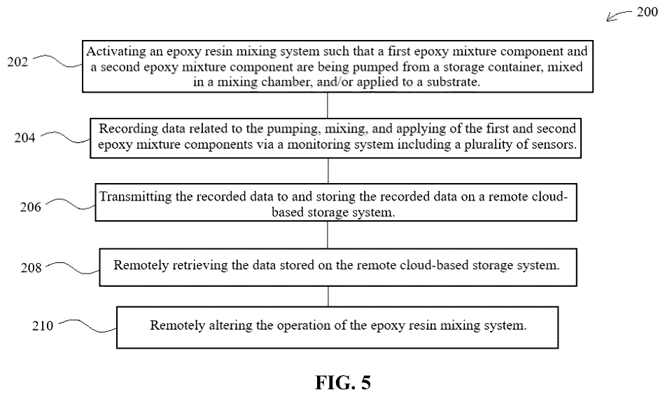

Referring to FIG. 5, a method 200 for recording, transferring, storing, and retrieving data related to the operation of epoxy resin mixing system 2 is shown, according to an exemplary embodiment. Method 200 includes steps 202, 204, 206, and 208. Step 202 includes activating epoxy resin mixing system 2 such that the first and second epoxy mixture components are being pumped from storage container 10, mixed in mixing chamber 18, and/or applied to substrate 8 after mixing.

Step 204 of method 200 includes recording data via monitoring system 16 related to the pumping of the first and second epoxy mixture components, the mixing of the epoxy mixture, and the application of the epoxy mixture. In some embodiments, the data recorded by monitoring system 16 includes data related to the flow of the first epoxy mixture component through first pipe 14a and collected by line sensors 22a and data related to the flow of the second epoxy mixture component through second pipe 14b and collected by line sensors 22b. Specifically, the data collected by line sensors 22a includes flow rate data of the first epoxy mixture component through first pipe 14a recorded by flow meter 24a, temperature of the first epoxy mixture component recorded by temperature sensor 26a, and pressure of the first epoxy mixture component within first pipe 14a recorded by pressure sensor 28a. The data collected by line sensors 22b includes flow rate data of the second epoxy mixture component through second pipe 14b recorded by flow meter 24b, temperature of the second epoxy mixture component recorded by temperature sensor 26b, and pressure of the second epoxy mixture component within second pipe 14b recorded by pressure sensor 28b.

In some embodiments, the data recorded by monitoring system 16 includes data recorded by aggregate speed sensor 40 and related to the amount of aggregate material that passes through aggregate inlet 21. The data recorded by monitoring system 16 includes location data recorded by GPS transponder 44, start and stop times of application of the epoxy mixture to substrate 8, and the length of the area of substrate 8 along which epoxy resin mixing system 2 has applied the epoxy mixture, as measured by linear pulse generator 48. The data recorded by monitoring system 16 can include the environmental weather conditions around epoxy resin mixing system 2 as recorded by weather station 50, such as temperature, humidity, moisture, rain fall, wind speed, wind direction, heat index, sun light intensity and/or noise level. In a specific embodiment, the data recorded by monitoring system 16 includes images of the installation area of substrate 8 throughout the mixing and applying process as recorded by camera 52 and surface profile and texture data of substrate 8 as recorded by laser texture scanning device 54.

Step 206 of method 200 includes transmitting the data recorded during step 204 to a remote cloud-based storage system 41. The data is transmitted to the cloud-based storage system 41 via data transmitter 43. The data is then stored on the cloud-based storage system 41. In a specific embodiment, the data recorded during step 204 is also stored on local storage device 42. In some embodiments, the data recorded during step 204 is printed off at epoxy resin mixing system 2 by paper printer 56. The data printed off by paper printer 56 can include data, time, location, quantity of materials applied, and application rate of materials.

Step 208 of method 200 includes retrieving the data transmitted to the cloud-based storage system 41 via a remote data retrieval device. In a specific embodiment, a mobile application is used to retrieve the data. The mobile application is configured to facilitate transfer of data between monitoring system 16, cloud-based storage system 41, and the remote data retrieval device through a cellular or wired network. The mobile application is accessible through mobile handheld phones and/or tablet devices and provides users with an interface to format data stored on cloud-based storage system 41 and transfer data between cloud-based storage system 41 and the remote data retrieval device. The mobile application is configured to be accessed by multiple classes of users having access to different subsets of the data stored at the cloud-based storage system 41. These classes of users include Department of Transportation inspectors, pump operators, contractor management, and remote equipment maintenance personnel.

In a specific embodiment, method 200 includes step 210. Step 210 includes remote control and programming of epoxy resin mixing system 2. Epoxy resin mixing system 2 is configured to receive inputs from remote users to repair or alter operational conditions of epoxy resin mixing system 2, such as by altering the flow rate of the first and/or second epoxy mixture components or the rate of application of the epoxy mixture to substrate 8. In some embodiments, the mobile application is used as an interface for remote users to send signals to epoxy resin mixing system 2 to alter the operational conditions of epoxy resin mixing system 2. The mobile application can be configured to notify users when data recorded by monitoring system 16 includes measured values outside of a predetermined acceptable range to allow users to alter the operating conditions of epoxy resin mixing system 2 as needed to remain in the predetermined acceptable range.

In alternative embodiments, epoxy resin mixing system 2 is used to mix adhesive mixtures other than epoxy adhesives, such as polyester adhesives, acrylic adhesives, and/or urethane adhesives. In a specific embodiment, the epoxy resin mixing system 2 mixes, monitors, and applies a polyester adhesive such that the term “first epoxy resin mixture component” described herein instead refers to a polyester resin, the term “second epoxy resin mixture component” described herein instead refers to a polyester adhesive mixture hardening agent, and the term “epoxy mixture” described herein instead refers to a polyester adhesive mixture. In some embodiments, epoxy resin mixing system 2 mixes, monitors, and applies an acrylic adhesive, such as methyl methacrylate (MMA), such that the term “first epoxy resin mixture component” described herein instead refers to an acrylic resin, such as MMA resin, the term “second epoxy resin mixture component” described herein instead refers to an acrylic adhesive mixture hardening agent, and the term “epoxy mixture” described herein instead refers to an acrylic adhesive mixture. In further embodiments, epoxy resin mixing system 2 mixes, monitors, and applies a urethane adhesive, such that the term “first epoxy resin mixture component” described herein instead refers to a urethane resin, the term “second epoxy resin mixture component” described herein instead refers to a urethane adhesive mixture hardening agent, and the term “epoxy mixture” described herein instead refers to a urethane adhesive mixture.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

As used herein, the article “a” is intended to include one or more component or element and is not intended to be construed as meaning only one. For purposes of this disclosure, the term “proximate” means within a distance of 25 feet.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed is:

1. A monitoring system for an epoxy resin mixer for use in applying epoxy mixtures to construction surfaces, the epoxy resin mixer including a mixing chamber, a first inlet pipe configured to direct a flow of resin into the mixing chamber, and a second inlet pipe configured to direct a flow of hardening agent into the mixing chamber, the monitoring system being used to monitor compliance of the applied epoxy mixture with predetermined specifications, the monitoring system comprising:
a first temperature sensor coupled to the first inlet pipe and configured to record the temperature of the resin within the first inlet pipe;
a first pressure sensor coupled to the first inlet pipe and configured to record the pressure of the resin within the first inlet pipe;
a first flow meter coupled to the first inlet pipe and configured to record the flow rate of the resin within the first inlet pipe;
a second temperature sensor coupled to the second inlet pipe and configured to record the temperature of the hardening agent within the second inlet pipe;
a second pressure sensor coupled to the second inlet pipe and configured to record the pressure of the hardening agent within the second inlet pipe;
a second flow meter coupled to the second inlet pipe and configured to record the flow rate of the hardening agent within the second inlet pipe;
a data transmitter configured to transmit recorded data to a remote cloud-based storage system, the recorded data comprising the temperature, pressure, and flow rate of the resin within the first inlet pipe and the temperature, pressure, and flow rate of the hardening agent within the second inlet pipe; and
wherein the remote cloud-based storage system is configured to transmit the recorded data to a remote data retrieval device, the remote data retrieval device accessing the recorded data through a mobile application.

2. The monitoring system of claim 1, further comprising a local memory storage device configured to store the first inlet data and the second inlet data at a location proximate to the monitoring system.

3. The monitoring system of claim 1, further comprising a GPS location tracking device; and
wherein the recorded data includes the location and time of operation of the epoxy resin mixer.

4. The monitoring system of claim 1, wherein the recorded data includes the length of a construction surface over which the epoxy resin mixer traveled while applying an epoxy mixture to the construction surface.

5. The monitoring system of claim 4, wherein the recorded data includes the application rate of the epoxy mixture to the construction surface.

6. The monitoring system of claim 1, further comprising a weather monitoring device; and
wherein the recorded data includes data related to environmental weather conditions proximate to the epoxy resin mixer during application of an epoxy mixture to a construction surface.

7. The monitoring system of claim 6, wherein the data related to the environmental weather conditions around the epoxy resin mixer during application of the epoxy mixture to the construction surface includes temperature, humidity, sunlight intensity, and amount of rain fall.

8. The monitoring system of claim 1, wherein the mobile application is configured to remotely alter the application rate of an epoxy mixture from the epoxy resin mixer to a construction surface.

9. The monitoring system of claim 1, further comprising a camera; and
wherein the recorded data includes an image of a construction surface after application of an epoxy mixture from the epoxy resin mixer.

10. The monitoring system of claim 1, further comprising a texture scanning device; and
wherein the recorded data includes a surface profile of a construction surface after application of an epoxy mixture from the epoxy resin mixer.

11. An epoxy application system for use in applying epoxy mixtures to construction surfaces and configured to monitor compliance of the applied epoxy mixture with predetermined specifications, the epoxy application system comprising:
a vehicle;
an epoxy resin mixer coupled to the vehicle;
a first inlet pipe configured to direct a flow of resin into the epoxy resin mixer;
a second inlet pipe configured to direct a flow of hardening agent into the epoxy resin mixer;
a monitoring system comprising:
a first temperature sensor coupled to the first inlet pipe and configured to record the temperature of the resin within the first inlet pipe;
a first pressure sensor coupled to the first inlet pipe and configured to record the pressure of the resin within the first inlet pipe;
a first flow meter coupled to the first inlet pipe and configured to record the flow rate of the resin within the first inlet pipe;
a second temperature sensor coupled to the second inlet pipe and configured to record the temperature of the hardening agent within the second inlet pipe;
a second pressure sensor coupled to the second inlet pipe and configured to record the pressure of the hardening agent within the second inlet pipe;
a second flow meter coupled to the second inlet pipe and configured to record the flow rate of the hardening agent within the second inlet pipe;
a data transmitter configured to wirelessly transmit recorded data to a remote cloud-based storage system, the recorded data comprising the temperature, pressure, and flow rate of the resin within the first inlet pipe and the temperature, pressure, and flow rate of the hardening agent within the second inlet pipe; and
wherein the remote cloud-based storage system is configured to transmit the recorded data to a remote data retrieval device.

12. The epoxy application system of claim 11, the monitoring system further comprising a GPS location tracking device; and
wherein the recorded data includes the location and time of operation of the epoxy resin mixer.

13. The epoxy application system of claim 11, wherein the recorded data includes the length of a construction surface over which the vehicle traveled while applying an epoxy mixture to the construction surface; and
wherein the recorded data includes the application rate of the epoxy mixture to the construction surface.

14. The epoxy application system of claim 11, the monitoring system further comprising a weather monitoring device; and
wherein the recorded data includes the temperature, humidity, sunlight intensity, and amount of rain fall in the environment proximate to the epoxy resin mixer during application of an epoxy mixture to a construction surface.

15. The epoxy application system of claim 11, wherein the epoxy resin mixer is configured to be remotely controlled such that a user can alter the application rate of an epoxy mixture from the epoxy resin mixer to a construction surface using the remote data retrieval device.

16. The epoxy application system of claim 11, the monitoring system further comprising a camera; and
wherein the recorded data includes an image of a construction surface after application of an epoxy mixture from the epoxy resin mixer.

17. The epoxy application system of claim 11, the monitoring system further comprising a texture scanning device; and
wherein the recorded data includes a surface profile of a construction surface after application of an epoxy mixture from the epoxy resin mixer.

18. The epoxy application system of claim 11, the monitoring system further comprising a paper printer configured to print at least a portion of the recorded data on paper proximate to the vehicle.

19. A method for operating and monitoring an epoxy resin mixer for use in applying epoxy mixtures to construction surfaces, the method comprising:
activating an epoxy resin mixing system such that a first epoxy resin mixture component and a second epoxy resin mixture component are pumped into a mixing chamber, mixed together, and applied to a construction surface;
recording data related to operation of the epoxy resin mixing system via a monitoring system;
transmitting the recorded data to a cloud-based storage system;
storing the recorded data on the cloud-based storage system;
remotely retrieving the recorded data from the cloud-based storage system using a data retrieval device;
wherein the monitoring system comprises:
a flow meter;
a temperature sensor;
a pressure sensor;
wherein the recorded data includes a flow rate, temperature, and pressure of at least one of the first epoxy mixture component and the second epoxy mixture component while being pumped within the epoxy resin mixing system; and
wherein the first epoxy mixture component is an epoxy resin and the second epoxy mixture component is a hardening agent.

20. The method of claim 19, further comprising remotely altering the rate at which the first epoxy resin mixture component and/or the second epoxy mixture component is pumped into the mixing chamber.
